(19) United States
(12) Patent Application Publication
(10) Pub. No.: US 2012/0131754 A1
(43) Pub. Date: May 31, 2012

(54) BLEACHING OF FOOD STAINS

(76) Inventors: Luca SARCINELLI, Cerveteri (Rome) (IT); Stefano Scialla, Rome (IT); Fernando Solache Leon, Newcastle (GB); Hansjoerg Hufnagel, Albano Laziale (IT)

(21) Appl. No.: 13/302,463

(22) Filed: Nov. 22, 2011

(30) Foreign Application Priority Data
Nov. 25, 2010 (EP) 10192585.7
Oct. 20, 2011 (EP) 11185907.0

(51) Int. Cl. D06L 3/16; C11D 7/60; C09K 3/00

(52) U.S. Cl. 8/137; 252/186.1; 252/186.42; 252/186.39; 510/305; 510/306; 510/309

(57) ABSTRACT

The need for a bleaching composition providing improved removal of fatty stains and red food stains, particularly during low temperature washing, can be met by incorporating an aryliminium organic bleach catalyst, an activated peroxygen source, and a bleach activator, in specific levels.

### FIELD OF THE INVENTION

The present invention relates to the improved removal of stains, particularly fatty stains and red food stains, through the use of bleaching compositions that comprise an aryliminium organic bleach catalyst, a peroxygen source, and a bleach activator.

### BACKGROUND OF THE INVENTION

Today's consumer desires bleaching compositions for addition during a laundry cycle that remove a broad array of stains, preferably without requiring a pretreatment step. However, certain stains are more difficult to remove than others—particularly at low wash temperatures. Such stains include those derived from animal and vegetable fats, as well as red food stains such as those derived from tomato sauce, carrot, and the like.

The use of peroxygen sources such as hydrogen peroxide, as well as various peracids and their salts, is well known in the Art. A means of improving bleaching is through a combination of the peroxygen source with a bleach activator. However, the level of stain removal and whiteness benefit is still less than desired, particularly for hard to remove stains such as certain fats, or very visible stains such as red food stains. Stain removal is improved by washing and bleaching at high temperatures. However, washing at high temperature damages delicate fabrics, and leads to accelerated colour fading. Bleaching performance, including at low temperatures, can be enhanced by using an organic bleach catalyst. However, even with a combination of a peroxygen source and an organic bleach catalyst, removal of fatty stains and red food stains has remained unsatisfactory, particularly during low temperature bleaching.

Accordingly, there remains a need for a bleaching composition that delivers improved bleaching of fatty stains and red food stains, even during low temperature laundry.

WO 2009/060421 discloses cleaning compositions comprising organic bleach catalysts having enhanced enzyme compatibility, processes for making such compositions, and the use of such cleaning compositions. WO 2007/087242 discloses compositions comprising a lipase enzyme in combination with a bleach catalyst that is capable of accepting an oxygen atom from a peroxyacid and transferring the oxygen atom to an oxidizable surface.

### SUMMARY OF THE INVENTION

It has surprisingly been discovered that a bleaching composition comprising: from 0.02% to 0.20% by weight of an aryliminium organic bleach catalyst selected from the group consisting of: aryliminium cations, aryliminium zwitterions, and mixtures thereof; from 25% to 50% of a peroxygen source; and from 5% to 20% by weight of a bleach activator, delivers improved removal of fatty stains and red food stains, even at low temperatures.

### DETAILED DESCRIPTION OF THE INVENTION

When an aryliminium organic bleach catalyst, a suitable peroxygen source, and a bleach activator are combined together in the levels according to the present invention, the resultant composition delivers significantly enhanced stain removal from treated fabrics. The stain removal benefit is particularly apparent for fatty stains and red food stains, even during low temperature bleaching (at less than 40° C., preferably less than 30° C., and more preferably less than 20° C.).

All percentages, ratios and proportions used herein are by weight percent of the composition, unless otherwise specified. All average values are calculated “by weight” of the composition or components thereof, unless otherwise expressly indicated.

### The Bleaching Composition

The bleaching compositions of the present invention comprise: an aryliminium organic bleach catalyst, a peroxygen source, and a bleach activator, to provide improved stain removal, particularly removal of fatty stains and red food stains. The preferred weight ratio of bleach activator to the aryliminium organic bleach catalyst is from 30:1 to 3000:1, more preferably from 40:1 to 2000:1, and even more preferably from 50:1 to 1000:1. The preferred weight ratio of the peroxygen source to the aryliminium organic bleach catalyst is from 100:1 to 1000:1, more preferably from 100:1 to 500:1, and even more preferably from 150:1 to 400:1.

Suitable forms include particulate compositions, and liquid compositions, though particulate compositions are preferred. By “particulate” it is meant herein powders, pearls, granules, tablets and the like. Particulate compositions are preferably dissolved in an appropriate solvent, typically water, before being applied onto the fabrics to be treated.

The compositions of the present invention are preferably granular particulate compositions. These compositions can be made by a variety of methods well known in the art, including dry-mixing, spray drying, agglomeration and granulation and combinations thereof. The compositions herein can be prepared with different bulk densities, including for conventional granular products having a bulk density of from 500 g/l, to 700 g/l. However, “concentrated” particulate bleaching compositions are preferred, having a bulk density preferably greater than 600 g/l, more preferably from 600 g/l, to 1200 g/l, most preferably 800 g/l to 1100 g/l.

The bleaching composition may also be a liquid, though care has to be taken to chemically separate the peroxygen source from the aryliminium organic bleach catalyst, and the bleach activator. For instance, the peroxygen source maybe at least partially physically separated from the aryliminium organic catalysts and bleach activator, such that the peroxygen source and organic bleach catalyst are unable to interact chemically. In one embodiment, at least 50%, preferably 80%, more preferably 100%, by weight of the peroxygen source is encapsulated by a water-soluble or dispersible barrier which keeps the majority of the peroxygen source isolated from the aryliminium organic bleach catalyst and bleach activator. Suitable water-soluble or dispersible barrier materials include carbohydrates, natural or synthetic gums, chitin and chitosan, cellulose and cellulose derivatives, polyvinyl alcohol and polyvinyl alcohol derivatives, polyvinyl acetate, polyethylene glycol, synthetic and natural waxes, gelatin, alginates, acrylic polymers and their derivatives, starch materials, an inorganic coating (silicates, phosphates, carbonates, zeolites, alumina and mixtures thereof), urea-formaldehyde, melamine-formaldehyde, fatty acids, polyurethanes, polyamides, polyureas, polyesters and mixtures thereof. Preferred water-soluble or dispersible barrier materials are: chitin and chitosan, polyvinyl alcohol and polyvinyl alcohol derivatives, alginates, starch materials, urea-formaldehyde, melamine-formaldehyde, and mixtures thereof. In yet another embodiment, the liquid bleaching composition is comprised in at least two separate compartments, with at least 50%, preferably at least 80%, more preferably 100%, by weight of the peroxygen source in a compartment comprising less than 25%, preferably less than 10%, more preferably less than 1%, by weight of the aryliminium organic bleach catalyst and bleach activator. By a similar means, the peroxygen source can be physically separated from ingredients such as enzymes and perfumes that are sensitive to bleaching agents.

Preferably, the bleaching compositions of the present invention are bleaching additive compositions. Additive compositions are generally added together with a laundry detergent composition into a washing machine, to improve fabric whitening and stain removal, and are active in the same wash-cycle. By contrast, so-called ‘spotter’ or ‘pretreater’ compositions are generally applied undiluted onto fabrics, prior to washing or rinsing the fabrics and are left to act thereon for an effective amount of time. ‘Soakers’ are contacted, mostly in diluted form, with fabrics prior to washing or rinsing of the fabrics with water. ‘Rinse-added’ compositions are contacted, mostly in diluted form, with fabrics during rinsing of the fabrics with water.

The bleaching compositions herein preferably have a pH, when diluted into 500 times its weight of water, and measured at 25° C., of from 7 to less than 12, more preferably from 7.5 to less than 11, most preferably from 8 to less than 11.

### The Bleaching System:

The bleaching composition comprises an organic bleach catalyst, a peroxygen source, and a bleach activator. Organic bleach catalysts improve the bleaching performance, particularly at low temperatures. They are capable of accepting an oxygen atom from a peroxygen source and transferring the oxygen atom to an oxidizable substrate. The bleaching system for use in the present invention may also include other bleaching agents such as: additional bleach activators, metal-containing bleach catalysts, transition metal complexes of macropolycyclic rigid ligands, and mixtures thereof.

1) Organic Bleach Catalyst:

The bleaching composition of the present invention comprises from 0.02% to 0.20%, preferably from 0.05% to 0.15%, more preferably from 0.08% to 0.15% by weight of an aryliminium organic bleach catalyst selected from the group consisting of: aryliminium cations, aryliminium zwitterions, and mixtures thereof.

Aryliminium zwitterions: Suitable aryliminium zwitterions maybe selected from the group consisting of:
a)

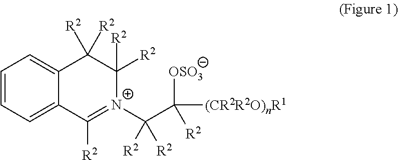

wherein: in FIG. 1, R¹ is selected from the group consisting of: H, a branched alkyl group containing from 3 to 24 carbons, and a linear alkyl group containing from 1 to 24 carbons. Preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons. Preferably R² is independently selected from H and methyl groups; n is an integer from 0 to 1;
b)

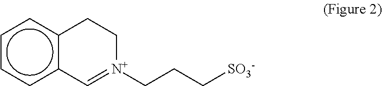

3-(3,4-dihydroisoquinolinium)propane sulphonate;

and mixtures thereof.

More preferably, the aryliminium zwitterions have the structure:

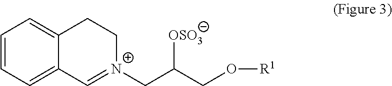

wherein: in FIG. 3, R¹ is a branched alkyl group containing from 9 to 24 carbons or linear alkyl group containing from 11 to 24 carbons, preferably, each R¹ is a branched alkyl group containing from 9 to 18 carbons or linear alkyl group containing from 11 to 18 carbons, more preferably each R¹ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Suitable aryliminium zwitterions include those listed in Table 1a, Table 1b, and mixtures thereof. Preferred aryliminium zwitterions are those listed in Table 1b, and mixtures thereof. Most preferred, are the inner salts of 3-(3,4-dihydroisoquinolinium) propane sulphonate, sulphuric acid mono-[2-(3,4-dihydro-isoquinolin-2-yl)-1-(2-butyl-octyloxymethyl)-ethyl]ester, and mixtures thereof. Other suitable examples of aryliminium organic bleach catalysts can be found in U.S. Pat. No. 5,576,282 and U.S. Pat. No. 5,817,614, EP 923,636 B1, WO 2001/16263 A1, WO 2000/42156 A1, WO 2007/001262 A 1.

Aryliminium cations: Suitable cations and polycations include aryliminium ions having the structure:

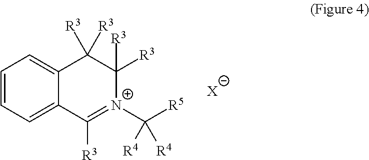

wherein: in FIG. 4, R³ is independently selected from the group consisting of: H and methyl groups. Preferably, R³ is H. R⁴ and R⁵ are independently selected from the group consisting of: H, a branched alkyl group containing from 3 to 12 carbons, and a linear alkyl group containing from 1 to 12 carbons. Preferably, R⁴ and R⁵ are H or methyl, more preferably, R⁴ and R⁵ are H. X⁻ is a charge-balancing counter-ion; preferably a bleach-compatible counter-ion. Suitable aryliminium cations include those listed in Table 2, and mixtures thereof. Most preferred, are N-methyl-3,4-dihydroisoquinolinium tetrafluoroborate, N-methyl-3,4-dihydroisoquinolinium p-toluene sulphonate, and mixtures thereof.

### 2) Peroxygen Sources:

The peroxygen source supplies the oxygen atoms that are transferred to the oxidizable substrate and as such, are an essential feature of the bleaching system. The bleaching composition comprises from 25% to 50%, preferably from 25% to 45%, more preferably from 25% to 40%, most preferably from 25% to 35%, by weight of a peroxygen source.

The peroxygen source is preferably selected from the group consisting of: phthalimido peroxycaproic acid (PAP), perborate salts, percarboxylic acids and salts, percarbonic acids, percarbonates, perimidic acids and salts, peroxymonosulphuric acids and salts, urea peroxide, and mixtures thereof. Percarbonates are particularly preferred for their greater rate of dissolution, a more environmentally friendly profile and the advantage of concurrently generating hydrogen peroxide, while also liberating carbonate. Thus, they give a higher pH than perborates and favour perhydrolysis. Sodium percarbonate is a suitable percarbonate. Perborate sources, such as sodium perborate, have good stability and selectivity. Other preferred perborate sources include the tetrahydrate and/or the monohydrate. Another preferred peroxygen source is phthalimido peroxycaproic acid (PAP). A suitable salt of a peroxymonosulphuric acid is potassium peroxymonosulphate (potassium monopersulphate), or its triple salt: 2 KHSO5.KHSO4.K2SO4.

Other suitable persalts include: persulphates, perphosphates, persilicates, and mixtures thereof.

Peroxides are also suitable peroxygen sources. Typical peroxides include organic peroxides, such as diacyl peroxides (DAP), which do not cause visible spotting or filming. Diacyl peroxides improve bleaching of specific stains such as stains caused by spaghetti sauce or barbecue sauce. One suitable example is dibenzoyl peroxide. Other suitable hydrogen peroxide sources are described in detail in Kirk Othmer's Encyclopaedia of Chemical Technology, 4th Ed (1992, John Wiley & Sons), Vol. 4, pp. 271-300 “Bleaching Agents (Survey)”. Since peroxyacid acids are particularly useful for removing dingy soils from textiles, the bleaching composition preferably comprises peroxyacid in combination with DAP, to bleach both dingy stains as well as stains resulting from spaghetti and the like. As used herein, “dingy soils” are those which build up on textiles after numerous cycles of usage and washing and thus, cause the white textile to have a gray or yellow tint.

### 3) The Bleach Activator:

The bleaching composition of the present invention is formulated with from 5% to 20%, preferably from 7% to 18%, more preferably from 8% to 16%, most preferably from 10 to 12%, by weight of a bleach activator, in combination with the aryliminium organic bleach catalyst and peroxygen source.

Suitable bleach activators include alkanoyloxybenzene sulphonates, particularly C4-C12 alkanoyloxybenzene sulphonates.

The bleach activator is preferably selected from the group consisting of: alkali metal alkanoyloxybenzene sulphonates, tetraacetyl ethylene diamine (TAED), and mixtures thereof. Preferred alkali metal alkanoyloxybenzene sulphonates include: sodium nonanoyloxybenzene sulphonate (NOBS), sodium 4-(isononanoyloxy)benzene sulphonate (iso-NOBS), sodium decanoyloxybenzene sulphonate, sodium dodecanoyloxybenzene sulphonate, and mixtures thereof. Tetraacetyl ethylene diamine (TAED) is preferred. To further increase bleaching efficacy, combinations of bleach activators are preferred. Preferred mixtures of bleach activators include nonanoyloxybenzene sulphonate (NOBS) in combination with a second bleach activator having a lower tendency to generate diacyl peroxide, but which delivers mainly peracid. Said second bleach activator may include tetracetyl ethylene diamine (TAED), acetyl triethyl citrate (ATC), pentaacetyl glucose, acetyl caprolactam, benzoyl caprolactam and the like, or mixtures thereof. For instance, the bleaching composition may comprise both tetraacetyl ethylene diamine (TAED), and nonanoyloxybenzene sulphonate (NOBS). The ratio of nonanoyloxybenzene sulphonate (NOBS) to said second bleach activator is preferably from 1:5 to 2:1, more preferably from 1:3 to 1:1. Indeed, it has been found that mixtures of bleach activators comprising nonanoyloxybenzene sulphonate and said second bleach activator further boost particulate soil removal performance, while exhibiting at the same time good performance on diacyl peroxide sensitive soils (e.g., beta-carotene) and on peracid sensitive soils (e.g., body soils).

In a preferred embodiment, the bleach activator used in the liquid bleach composition has the general formula:

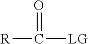

wherein R is an alkyl group, linear or branched, containing from 1 to 11 carbon atoms and LG is a suitable leaving group. As used herein, a “leaving group” is any group that is displaced from the bleach activator as consequence of nucleophilic attack on the bleach activator by the perhydroxide anion, i.e. perhydrolysis reaction.

Generally, a suitable leaving group is electrophilic and is stable such that the rate of the reverse reaction is negligible. This facilitates the nucleophilic attack by the perhydroxide anion. The leaving group must also be sufficiently reactive for the reaction to occur within the optimum time frame, for example during the wash cycle. However, if the leaving group is too reactive, the bleach activator will be difficult to stabilize.

These characteristics are generally paralleled by the pKa of the conjugate acid of the leaving group. The conjugate acid of the leaving group in accordance with the present invention preferably has a pKa in a range of from 4 to 13, more preferably from 6 to 11, and most preferably from 8 to 11.

Preferably, the leaving group has the formula:

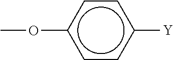

wherein Y is selected from the group consisting of SO₃⁻M⁺, COO⁻M⁺, SO₄⁻M⁺, PO₄⁻M⁺, PO₃⁻M⁺. (N⁺R²₃)X⁻ and O←N(R²₂), M is a cation and X is an anion, both of which provide solubility to the bleach activator, and R² is an alkyl chain containing from 1 to 4 carbon atoms or H. In accordance with the present invention, M is preferably an alkali metal, with sodium being most preferred. Preferably, X is a hydroxide, methylsulphate or acetate anion.

Other suitable leaving groups have the following formulas:

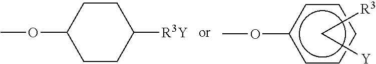

wherein Y is the same as described above and R³ is an alkyl chain containing from 1 to 8 carbon atoms, H or R².

While the numerous bleach activators described above are suitable for use in the present bleach compositions, a preferred bleach activator has the formula:

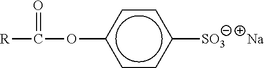

wherein R is an alkyl chain, linear or branched, containing from 1 to 11 carbon atoms. More preferably, R is an alkyl chain, linear or branched, containing from 3 to 11, even more preferably from 8 to 11.

Most preferably, according to the present invention, the bleach activator has the formula:

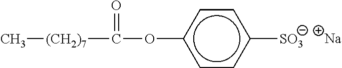

which is also referred to as sodium n-nonyloxybenzene sulphonate (hereinafter referred to as “NOBS”).

This bleach activator and those described previously may be readily synthesized by well known reaction schemes or purchased commercially. Those skilled in the art will appreciate that other bleach activators beyond those described herein, which are readily water-soluble, can also be used in the present bleach composition without departing from the scope of the invention.

While not intending to be limited by theory, it is believed that the bleach activator undergoes nucleophilic attack by a perhydroxide anion, for example from aqueous hydrogen peroxide, to form a percarboxylic acid. This reaction is commonly referenced to in the art as perhydrolysis.

Further, it is believed that bleach activators within the scope of the invention render the peroxygen bleaches more efficient even at bleach solution temperatures wherein the bleach activators are not necessary to activate the bleach, for example at temperatures above 60° C. As a consequence, less peroxygen bleach is required to obtain the same level of surface bleaching performance as compared with peroxygen bleach alone.

### 4) Other Bleaching Agents:

Metal-containing bleach catalysts: Preferred bleach catalysts include manganese and cobalt-containing bleach catalysts. Other suitable metal-containing bleach catalysts include catalyst systems comprising a transition metal cation of defined bleach catalytic activity, such as copper, iron, titanium, ruthenium tungsten, molybdenum, or manganese cations; an auxiliary metal cation having little or no bleach catalytic activity, such as zinc or aluminium cations; and a sequestrate having defined stability constants for the catalytic and auxiliary metal cations, particularly ethylenediaminetetraacetic acid, ethylenediaminetetra (methylenephosphonic acid) and water-soluble salts thereof. Suitable catalyst systems are disclosed in U.S. Pat. No. 4,430,243.

Transition metal complexes: The bleaching compositions herein may also include bleach catalysts comprising a transition metal complex, preferably of a macropolycyclic rigid ligand. The amount used is preferably from 0.0001% to 5%, more preferably from 0.001% to 2%, most preferably from 0.01% to 1% by weight of the bleaching composition.

### 5) Preferred Bleaching Systems:

Particularly preferred are bleaching composition, wherein the bleaching composition comprises:
(a) from 0.08% to 0.15% by weight of an aryliminium organic bleach catalyst, wherein the aryliminium organic bleach catalyst is an aryliminium zwitterion having the structure:

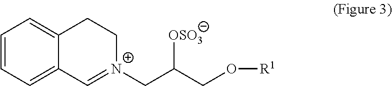

wherein: in FIG. 3,
R¹ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl, and mixtures thereof.
(b) from 25% to 40%, preferably from 25% to 35%, by weight of a peroxygen source, wherein the peroxygen source is a percarbonate, preferably sodium percarbonate; and
(c) from 7.0% to 18%, preferably from 8% to 16%, more preferably from 10% to 12%, by weight of a bleach activator, wherein the bleach activator comprises tetraacetyl ethylene diamine (TAED).

### Optional Ingredients

The bleaching compositions herein may further comprise other optional ingredients such as: surfactants, enzymes, fillers, chelating agents, radical scavengers, antioxidants, stabilizers, builders, soil suspending polymer, polymeric soil release agents, dye transfer inhibitor, solvents, suds controlling agents, suds booster, brighteners, perfumes, pigments, dyes and the like.

### 1) Surfactants

Since the bleaching composition is formulated to be added together with a laundry detergent composition, the bleaching composition comprises only minimal amounts of anionic or nonionic surfactant, if any. However, the presence of small amounts of such surfactants, particularly non-ionic surfactants, is useful for preventing the formation of fine airborne dust particles when the bleaching composition is handled, for example during transfer to a washing machine. Therefore, the bleaching composition preferably comprises at least 0.1%, and preferably less than 0.10%, more preferably less than 5%, most preferably 3% by weight of a surfactant selected from the group consisting of: anionic surfactants, non-ionic surfactants, and mixtures thereof.

Suitable anionic surfactants include alkyl sulphate surfactants. Preferred alkyl sulphate surfactants include water soluble salts or acids of the formula ROSO₃M wherein R is preferably a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a suitable cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below 50° C.) and C₁₆₋₁₈ alkyl chains are preferred for higher wash temperatures (e.g., above 50° C.).

Suitable anionic surfactants also include alkyl alkoxylated sulphate surfactants, including water soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like.

Preferred surfactants for use in the compositions according to the present invention are the alkyl sulphates, alkyl alkoxylated sulphates, and mixtures thereof. Other preferred surfactants for use in the compositions according to the present invention are acyl sarcosinates surfactants.

Suitable nonionic surfactants include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements. Preferred for use in the present invention are nonionic surfactants such as the polyethylene oxide condensates of alkyl phenols, e.g., the condensation products of alkyl phenols having an alkyl group containing from 6 to 16 carbon atoms, in either a straight chain or branched chain configuration, with from 4 to 25 moles of ethylene oxide per mole of alkyl phenol.

Other preferred nonionic surfactants are the water-soluble condensation products of aliphatic alcohols containing from 8 to 22 carbon atoms, in either straight chain or branched configuration, with an average of up to 25 moles of ethylene oxide per more of alcohol. Particularly preferred are the condensation products of alcohols having an alkyl group containing from 9 to 15 carbon atoms with from 2 to 10 moles of ethylene oxide per mole of alcohol; and condensation products of propylene glycol with ethylene oxide. Most preferred are condensation products of alcohols having an alkyl group containing from 12 to 15 carbon atoms with an average of 3 moles of ethylene oxide per mole of alcohol.

Other suitable surfactants according to the present invention includes also cationic, ampholytic, zwitterionic, and semi-polar surfactants, as well as nonionic surfactants other than those already described herein, including the semi-polar nonionic amine oxides described below. Particularly suitable surfactants for use herein are: nonionic surfactants such as alkoxylated nonionic surfactants, polyhydroxy fatty acid amide surfactants, amine oxides, zwitterionic surfactants such as zwitterionic betaine surfactants and mixtures thereof.

Ampholytic surfactants are also suitable for use in the bleaching compositions of the present invention. These surfactants can be broadly described as aliphatic derivatives of secondary or tertiary amines, or aliphatic derivatives of heterocyclic secondary and tertiary amines, in which the aliphatic radical can be straight- or branched chain. One of the aliphatic substituents contains at least 8 carbon atoms, typically from 8 to 18 carbon atoms, and at least one contains an anionic water-solubilizing group e.g. carboxy, sulphonate, sulphate. See U.S. Pat. No. 3,929,678 to Laughlin et al., issued Dec. 30, 1975 at column 19, lines 18-35 for examples of ampholytic surfactants.

Zwitterionic surfactants are also suitable for use in bleaching compositions. These surfactants can be broadly described as derivatives of secondary and tertiary amines, derivates of heterocyclic secondary and tertiary amines, or derivatives of quaternary ammonium, quaternary phosphonium or tertiary sulphonium compounds. See U.S. Pat. No. 3,929,678 to Laughlin et al., issued Dec. 30, 1975 at columns 19, line 38 through column 22, line 48 for examples of zwitterionic surfactants.

Semi-polar nonionic surfactants are a special category of nonionic surfactants which include water-soluble amine oxides containing one alkyl moiety of from 10 to 18 carbon atoms and 2 moieties selected from the group consisting alkyl groups and hydroxyalkyl groups containing from 1 to 3 carbon atoms; water-soluble phosphonic oxides containing one alkyl moiety of form 10 to 18 carbon atoms and 2 moieties selected form the group consisting of alkyl groups and hydroxyalkyl groups containing from 1 to 3 carbon atoms. Semi-polar nonionic detergent surfactants include the amine oxide surfactants having the formula R³(OR⁴)ₓNO(R⁵)₂

### 2) Enzymes:

The bleaching composition of the present invention may comprise from 0.0001% to 8% by weight of an enzyme which provides cleaning performance and/or fabric care benefits. Such compositions preferably have a composition pH of from 6 to 10.5. Suitable enzymes can be selected from the group consisting of: lipase, protease, amylase, cellulase, pectate, lyase, xyloglucanase, and mixtures thereof. Bleaching compositions wherein the detersive enzyme is lipase and the bleach activator is sodium nonanoyloxybenzenesulphonate (NOBS) are particularly preferred. Detersive enzymes are described in greater detail in U.S. Pat. No. 6,579,839.

### 3) Fillers:

The compositions of the present invention may comprise a filler salt as a highly preferred though optional ingredient. Suitable filler salts herein are selected from the group consisting of sodium sulphate, sodium chloride, sodium tripolyphosphate “STPP” and the like. Typically, the compositions according to the present invention may comprise up to 75% by weight of the total composition of a filler salt or a mixture thereof, preferably from 10% to 70% and more preferably from 30% to 60% by weight of a filler salt.

### 4) Chelating Agents

The compositions of the present invention may comprise a chelating agent. Typically, the compositions according to the present invention can comprise up to 5% by weight of the total composition of a chelating agent, or mixtures thereof, preferably from 0.01% to 1.5% by weight and more preferably from 0.01% to 0.5%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

### 5) Anti-Redeposition Polymers:

The leaching composition may comprise up to 10% by weight of the total composition of an anti-redeposition polymer or a soil suspending polymer, such as a soil suspending polyamine polymer, preferably from 0.1% to 5% and more preferably from 0.3% to 2%.

Suitable anti-redeposition polymers include polymeric polycarboxylates and polyacrylates polymers, preferably having a weight average molecular weight of from 1,000 Da to 20,000 Da. Suitable anti-redeposition polymers also include co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da. Suitable polycarboxylates are the Sokalan CP, PA and HP ranges (BASF) such as Sokalan CP5, PA40 and HP22, and the Alcosperse range of polymers (Alco) such as Alcosperse 725, 747, 408, 412 and 420.

Further suitable anti-redeposition polymers include cellulose derivatives, for example carboxymethyl cellulose, methylhydroxyethyl cellulose, and mixtures thereof. An example of a suitable carboxymethylcellulose is Finnfix® BDA, supplied by CPKelco, Arhem, Netherlands. An example of suitable methylhydroxymethyl cellulose is Tylose® MHSO G4, supplied by SE Tylose GmbH, Wiesbaden, Germany.

Further suitable anti-redeposition polymers include polyamine polymers known to those skilled in the art. Particularly suitable polyamine polymers for use herein are polyalkoxylated polyamines.

The compositions herein may also comprise other polymeric soil release agents known to those skilled in the art. Such polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures. If utilized, soil release agents will generally comprise from 0.01% to 10.0%, by weight, of the compositions herein, typically from 0.1% to 5%, preferably from 0.2% to 3.0%.

### 6) Dye Transfer Inhibitor

The compositions of the present invention may also include one or more materials effective for inhibiting the transfer of dyes from one dyed surface to another during the cleaning process. Generally, such dye transfer inhibiting agents include polyvinyl pyrrolidone polymers, polyamine N-oxide polymers, co-polymers of N-vinylpyrrolidone and N-vinylimidazole, manganese phthalocyanine, peroxidases, and mixtures thereof. If used, the bleaching composition comprises from 0.01% to 10%, preferably from 0.01% to 5%, and more preferably from 0.05% to 2% by weight of the dye transfer inhibitor.

### 7) Brightener

Any optical brighteners, fluorescent whitening agents or other brightening or whitening agents known in the art can be incorporated in the instant compositions when they are designed for fabric treatment or laundering, at levels typically from 0.05% to 1.2%, by weight, of the compositions herein.

### Method of Treating Fabrics

The present invention encompasses a method of removing fabric stains, particularly removing fatty stains, red food stains, or combinations thereof, comprising the steps of: forming an aqueous bleach-containing wash solution comprising the bleaching composition of any preceeding claim, a laundry detergent composition, and water; contacting the fabric with said bleach-containing wash solution; and subjecting said fabrics contacted with said bleach containing wash solution to a laundry wash cycle. Such a method typically includes the steps of forming an aqueous bath comprising water, a laundry detergent composition, preferably a granular laundry detergent, and a bleaching composition according to the present invention, and subsequently contacting said fabrics with said aqueous bath. Said bleaching compositions are typically dissolved in up to 500 times its own weight, preferably from 5 to 350 times and more preferably from 10 to 200 times.

Preferably, the aqueous bath comprises from 100 to 5000 ppm, more preferably from 200 to 4000 ppm, most preferably from 300 to 3000 ppm of the bleaching composition of the invention. Preferably, the aqueous bath comprises from 200 to 25000 ppm, more preferably from 300 to 15000 ppm, most preferably from 400 to 10000 ppm of the laundry detergent composition of the invention.

The method of removing fabric stains according to the present invention delivers effective stain removal and stain release performance, particularly of fatty stains and red food stains. The term ‘stain release’ refers to the ability of the composition to modify the surfaces of the textile over multiple wash cycles resulting in reduced adhesion of soils to the fabric. Fatty stains comprise chicken fat, beef fat, pork fat, and mixtures thereof. Red food stains comprise tomato juice, ragù sauce, carrot juice and mixture thereof.

By “laundry detergent composition” it is meant herein, laundry detergent compositions typically available on the market. Said laundry detergent composition comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH Powder®, ARIEL Tablets®, ARIEL Powder® and other products sold under the trade names ARIEL® or TIDE®. In a preferred embodiment herein, the laundry detergent composition is a particulate laundry detergent composition, more preferably in the form of a powder, pearl, granule or tablet.

In a preferred embodiment according to the present invention, the laundry detergent composition as described herein and, the bleaching composition herein are dissolved or dispersed, preferably substantially dissolved or dispersed, in the aqueous bath formed in the method according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said laundry detergent composition and/or said bleaching composition are dissolved or dispersed in the aqueous bath formed in the method according to the present invention.

The bleaching composition and the conventional detergent composition may be delivered into the washing machine either by charging the dispenser drawer of the washing machine with one or both of the detergents or by directly charging the drum of the washing machine with one or both of the detergents. More preferably the bleaching composition is directly placed into the drum of the washing machine, preferably using a dosing device, such as a dosing ball (such as the Vizirette®). Even more preferably the bleaching composition and the conventional detergent composition are both placed into the drum of the washing machine, preferably using suitable dosing devices such as dosing balls, dosing nets etc. The bleaching composition is preferably delivered to the main wash cycle of the washing machine before, but more preferably at the same time as the conventional detergent composition.

The present invention also incorporates the use of any of the bleaching composition of the present invention, for removing fatty stains, red food stains, and mixtures thereof, from fabrics.

### EXAMPLES

TABLE 1a
Examples of aryliminium zwitterions suitable for use in the
present invention:
3,4-dihydro-2-[2-(sulphooxy)decyl]isoquinolinium
3,4-dihydro-2-(2-sulphodecyl)-isoquinolinium, inner salt
3,4-dihydro-4,4-dimethyl-2-(2-sulphooctyl)-isoquinolinium, inner salt

TABLE 1b
Preferred aryliminium zwitterions for use in the present invention:
3-(3,4-dihydroisoquinolinium) propane sulphonate, internal salt
Sulphuric acid mono-[2-(3,4-dihydro-isoquinolin-2-yl)-
1-(2-propylheptyloxymethyl)-ethyl] ester, internal salt
Sulphuric acid mono-[2-(3,4-dihydro-isoquinolin-2-yl)-
1-(2-butyl-octyloxymethyl)-ethyl] ester, internal salt
Sulphuric acid mono-[2-(3,4-dihydro-isoquinolin-2-yl)-
1-(2-pentyl-nonyloxymethyl)-ethyl] ester, internal salt
Sulphuric acid mono-[2-(3,4-dihydro-isoquinolin-2-yl)-
1-(2-hexyl-decyloxymethyl)-ethyl] ester, internal salt
Sulphuric acid mono-[2-(3,4-dihydro-isoquinolin-2-yl)-
1-(dodecyloxymethyl)-ethyl] ester, internal salt
Sulphuric acid mono-[2-(3,4-dihydro-isoquinolin-2-yl)-
1-(tetradecyloxymethyl)-ethyl] ester, internal salt
Sulphuric acid mono-[2-(3,4-dihydro-isoquinolin-2-yl)-
1-(hexadecyloxymethyl)-ethyl] ester, internal salt
Sulphuric acid mono-[2-(3,4-dihydro-isoquinolin-2-yl)-
1-(octadecyloxymethyl)-ethyl] ester, internal salt
Sulphuric acid mono-[2-(3,4-dihydro-isoquinolin-2-yl)-
1-(iso-nonyloxymethyl)-ethyl] ester, internal salt
Sulphuric acid mono-[2-(3,4-dihydro-isoquinolin-2-yl)-
1-(iso-decyloxymethyl)-ethyl] ester, internal salt
Sulphuric acid mono-[2-(3,4-dihydro-isoquinolin-2-yl)-
1-(iso-tridecyloxymethyl)-ethyl] ester, internal salt

TABLE 2
Examples of aryliminium cations suitable for use in the present invention:
N-methyl-3,4-dihydroisoquinolinium tetrafluoroborate
N-methyl-3,4-dihydroisoquinolinium p-toluene sulphonate
N-octyl-3,4-dihydroisoquinoliniump-toluene sulphonate
3,4-dihydro-2,3,3-trimethyl-isoquinolinium tetrafluoroborate
3,4-dihydro-2,4,4-trimethyl-isoquinolinium tetrafluoroborate
2-(1,1-dimethylethyl)-3,4-dihydro-isoquinolinium tetraphenylborate

### Example 1

Bleaching compositions, comprising the following levels of peroxygen source (sodium percarbonate), bleach activator (tetraacetyl ethylene diamine), and aryliminium organic bleach catalyst (sulphuric acid mono-[2-(3,4-dihydro-isoquinolin-2-yl)-1-(2-butyl-octyloxymethyl)-ethyl]ester, internal salt) were prepared:

| | | | Wt % |
|---|---|---|---|
| | | | Sulphuric acid |
| | | | mono-[2-(3,4- |
| | | | dihydroiso- |
| | | | quinolin-2-yl)- |
| | | Wt % | 1-(2-butyloctyl- |
| | Wt % | Tetraacetyl | oxymethyl)- |
| Bleaching | Sodium | ethylene | ethyl] ester, |
| composition | percarbonate | diamine | internal salt |
| Composition A | 20% | 3% | — |
| (Comparative) | | | |
| Composition B | 25% | 5% | — |
| (Comparative) | | | |
| Composition C | 20% | 3% | 0.12% |
| (Comparative) | | | |
| Composition D | 25% | 5% | 0.12% |

Compositions A to D comprised the same amount of enzymes, aesthetics (perfume and colored speckles), chelants, surfactants, polymers and optical brightener.

The cotton test fabrics, prepared with chicken fat, pork fat, and beef fat stains were washed in conventional western European washing machines, using the 30° C. wash cycle, 30 g of the respective treatment composition and 120 g of liquid detergent (Western European Ariel detergent). Each stain was analyzed before and after treatment, using a spectrocolormeter (L, a, b), under D65 lighting. The stain level was measured using image analysis (Laundry Stain Removal Software, version 2.3.1.0).

The stain removal index is calculated according to the following formula:

$$Stain Removal Index = \frac{Δ {E}_{initial} - Δ {E}_{washed}}{Δ {E}_{initial}} \times 100$$

ΔEᵢₙᵢₜᵢₐₗ=Stain level before washing
ΔE_{washed}=Stain level after washing

| Stain | A | B | C | D |
|---|---|---|---|---|
| Chicken Fat | 40.8 | 33.2 | 37.2 | 49.2 |
| Pork Fat | 37.5 | 34.8 | 35.5 | 45.3 |
| Beef fat | 42.0 | 41.3 | 39.8 | 49.0 |

The test demonstrate that composition D, which combines the aryliminium organic bleach catalyst, peroxygen source, and bleach activator according to the present invention, is significantly better than comparative compositions: A, B, and C, at removing fatty stains such as chicken fat, beef fat, and pork fat.

### Example 2

Compositions E to H are also bleaching compositions according to the present invention:

| Ingredients | E | F | G | H |
|---|---|---|---|---|
| Sodium | 33.0 | 40.0 | 25.0 | 30.0 |
| percarbonate | | | | |
| Tetraacetyl | — | 9.0 | 4.4 | 4.0 |
| ethylene diamine | | | | |
| nonanoyloxybenzene | 15.0 | 6.7 | 6.6 | 6.7 |
| sulphonate | | | | |
| Organic Bleach | 0.02 | 0.15 | 0.05 | 0.12 |
| Catalyst (1) | | | | |
| Polyamine polymer | 6.0 | — | — | 6.0 |
| Acrylic Acid/Maleic | 2.0 | — | — | — |
| Acid Copolymer | | | | |
| (1-hydroxy-1- | 1.3 | — | 1.2 | — |
| phosphono-ethyl) | | | | |
| phosphonic | | | | |
| acid (HEDP) | | | | |
| Carboxymethyl | — | 0.1 | 0.5 | — |
| cellulose | | | | |
| Polyvinylpyrrolidone | — | 0.2 | 0.1 | — |
| (PVP) | | | | |
| C12-C16 | 1.2 | 4.5 | 3.7 | — |
| Alkylbenzene | | | | |
| sulphonic acid | | | | |
| C12-C16 alkyl | 0.5 | 1.0 | 0.4 | 0.1 |
| 7-ethoxylate | | | | |
| Sodium lauroyl | — | 1.0 | — | — |
| sarcosinate | | | | |
| Sodium xylene | — | 1.1 | — | — |
| sulphonate | | | | |
| Mannanase (2) | 0.2 | — | 0.1 | — |
| Protease (3) | — | 0.5 | 0.1 | — |
| Cellulase (4) | 0.2 | 0.2 | 0.1 | 0.1 |
| Lipase granulate (5) | 0.1 | 0.2 | 0.05 | 0.3 |
| Brightener | 0.1 | — | 0.07 | — |
| Sodium sulphate | Balance | Balance | Balance | Balance |

(1) Sulphuric acid mono-[2-(3,4-dihydro-isoquinolin-2-yl)-1-(2-butyl-octyloxymethyl)-ethyl] ester, internal salt
(2) Mannaway, from Novozymes (Denmark), 4 mg active enzyme per gram.
(3) Savinase, from Novozymes (Denmark), 15.8 mg active enzyme per gram.
(4) Celluclean, from Novozymes (Denmark), 15.6 mg active enzyme per gram.
(5) Lipex, from Novozymes (Denmark), 1.88 mg active enzyme per gram.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A bleaching composition comprising:
(a) from 0.02% to 0.20% by weight of an aryliminium organic bleach catalyst selected from the group consisting of: aryliminium cations, aryliminium zwitterions, and mixtures thereof;
(b) from 25% to 50% of a peroxygen source; and
(c) from 5% to 20% by weight of a bleach activator.

2. The bleaching composition according to claim 1, wherein the aryliminium organic bleach catalyst is an aryliminium zwitterion selected from the group consisting of:
a) 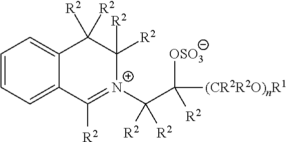
wherein:
(i) R¹ is selected from the group consisting of: H, a branched alkyl group containing from 3 to 24 carbons, and a linear alkyl group containing from 1 to 24 carbons;
(ii) R² is independently selected from the group consisting of: H, a branched alkyl group comprising from 3 to 12 carbons, and a linear alkyl group comprising from 1 to 12 carbons;
(iii) n is an integer from 0 to 1;
b) 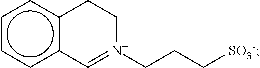
and mixtures thereof.

3. The bleaching composition according to claim 2, wherein the aryliminium zwitterion has the structure: 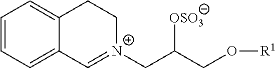
wherein R¹ is a branched alkyl group containing from 9 to 24 carbons or linear alkyl group containing from 11 to 24 carbons.

4. The bleaching composition according to claim 1, wherein the aryliminium organic bleach catalyst is an aryliminium cation having the structure: 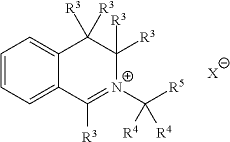
wherein:
(i) R³ is independently selected from the group consisting of: H and methyl groups;
(ii) R⁴ and R⁵ are independently selected from the group consisting of: H, a branched alkyl group containing from 3 to 12 carbons, and a linear alkyl group containing from 1 to 12 carbons; and
(iii) X⁻ comprises a charge-balancing counterion.

5. The bleaching composition according to claim 1, wherein the peroxygen source is selected from the group consisting of: phthalimido peroxycaproic acid (PAP), perborate salts, percarboxylic acids and salts, percarbonic acids, percarbonates, perimidic acids and salts, peroxymonosulphuric acids and salts, urea peroxide, and mixtures thereof.

6. The bleaching composition according to claim 5, wherein the peroxygen source comprises a percarbonate.

7. The bleaching composition according to claim 1, wherein the bleach activator is selected from the group consisting of: nonanoyloxybenzene sulphonate (NOBS), sodium 4-(isononanoyloxy)benzenesulphonate (iso-NOBS), decanoyloxybenzene sulphonate (DOBS), dodecanoyloxybenzene sulphonate (LOBS), tetraacetyl ethylene diamine (TAED), pentaacetyl glucose, and mixtures thereof.

8. The bleaching composition according to claim 7, wherein the bleach activator comprises tetraacetyl ethylene diamine (TAED).

9. The bleaching composition according to claim 1, wherein the bleach activator comprises nonanoyloxybenzene sulphonate (NOBS) and a second bleach activator.

10. The bleaching composition according to claim 1, further comprising a detersive enzyme selected from the group consisting of lipase, protease, amylase, cellulase, pectate lyase, xyloglucanase, and mixtures thereof.

11. The bleaching composition according to claim 10, wherein the detersive enzyme comprises lipase, and the bleach activator comprises sodium nonanoyloxybenzenesulphonate (NOBS).

12. The bleaching composition according to claim 1, wherein the bleaching composition further comprises less than 10% by weight of a surfactant selected from the group consisting of anionic surfactants, non-ionic surfactants, and mixtures thereof.

13. The bleaching composition according to claim 1, wherein the bleaching composition comprises:
(a) from 0.1% to 0.15% by weight of an aryliminium organic bleach catalyst, wherein the aryliminium organic bleach catalyst is an aryliminium zwitterion having the structure: 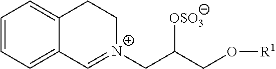
wherein:
R¹ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl, and mixtures thereof.
(b) from 25% to 40% by weight of a peroxygen source, wherein the peroxygen source comprises percarbonate; and
(c) from 7.0% to 18% by weight of a bleach activator, wherein the bleach activator comprises tetraacetyl ethylene diamine (TAED).

14. A method for removing fabric stains comprising the steps of:
(a) forming an aqueous bleach-containing wash solution comprising the bleaching composition of claim 1, a laundry detergent composition, and water;
(b) contacting a fabric with said bleach-containing wash solution; and
(c) subjecting said fabric contacted with said bleach containing wash solution to a laundry wash cycle.

15. The method according to claim 14, wherein said method is utilized for removing fatty stains, red food stains, or combinations thereof.
